(19) United States
(12) Patent Application Publication
(10) Pub. No.: US 2026/0353331 A1
(43) Pub. Date: Nov. 5, 2026

(54) SENSING METHODS AND DEVICE FOR A MOBILE NETWORK, STORAGE MEDIUM, SENSING ENTITY AND SENSING APPLICATION FUNCTION NETWORK ELEMENT

(71) Applicant: Beijing Xiaomi Mobile Software Co., Ltd., Beijing (CN)

(72) Inventor: Jinhua WU, Beijing (CN)

(21) Appl. No.: 19/119,385

(22) PCT Filed: Oct. 9, 2022
(86) PCT No.: PCT/CN2022/124223

§ 371 Date: Apr. 8, 2025

(51) Int. Cl. H04W 60/04; H04W 4/38

(52) U.S. Cl. CPC H04W 60/04; H04W 4/38

(57) ABSTRACT

A sensing method for a mobile network, including: transmitting, in response to a trigger-sensing request, a registration request to a sensing application function network element, where the registration request includes a type of the sensing entity and a capability of the sensing entity, and the sensing application function network element is configured to provide sensing service for the sensing entity; receiving a sensing registration accept message from the sensing application function network element, and receiving a sensing request from the sensing application function network element; and transmitting a sensing response message to the sensing application function network element.

### CROSS-REFERENCE TO RELATED APPLICATION

The present application is a U.S. National Stage of International Application No. PCT/CN2022/124223, filed on Oct. 9, 2022, the contents of all of which are incorporated herein by reference in their entirety for all purposes.

### BACKGROUND OF THE INVENTION

As a current mainstream technology of wireless communication, a wireless sensing technology has been applied to diverse aspects of social production, business activities and daily life. A wireless signal reaches a receiver after being reflected by a surrounding object during transmission. The receiver infers information such as a position, a speed, an orientation, etc., of the surrounding object by analyzing physical characteristics of the wireless signal.

### SUMMARY OF THE INVENTION

The present disclosure relates to the technical field of communication, and in particularly, to a sensing method and device for a mobile network, a storage medium, a sensing entity, and a sensing application function network element.

A first aspect of embodiments of the present disclosure provides a sensing method for a mobile network. The method is performed by a sensing entity. The method includes:
transmitting, in response to a trigger-sensing request, a registration request to a sensing application function network element, where the registration request includes a type of the sensing entity and a capability of the sensing entity, and the sensing application function network element is configured to provide a sensing service for the sensing entity;
receiving a sensing registration accept message from the sensing application function network element, and receiving a sensing request from the sensing application function network element; and
transmitting a sensing response message to the sensing application function network element.

A second aspect of embodiments of the present disclosure provides a sensing method for a mobile network. The method is performed by a sensing application function network element. The method includes:
receiving a registration request from a sensing entity, where the registration request includes a type of the sensing entity and a capability of the sensing entity, and the sensing application function network element is configured to provide a sensing service for the sensing entity;
transmitting a sensing registration accept message to the sensing entity, and transmitting a sensing request to the sensing entity; and
receiving a sensing response message from the sensing entity.

A third aspect of embodiments of the present disclosure provides a sensing device for a mobile network. The device is applied to a sensing entity. The device includes:
a registration request transmission module, configured to transmit, in response to a trigger-sensing request, a registration request to a sensing application function network element, where the registration request includes a type of the sensing entity and a capability of the sensing entity, and the sensing application function network element is configured to provide a sensing service for the sensing entity;
an information reception module, configured to receive a sensing registration accept message from the sensing application function network element, and receive a sensing request from the sensing application function network element; and
a response message transmission module, configured to transmit a sensing response message to the sensing application function network element.

A fourth aspect of embodiments of the present disclosure provides a sensing device for a mobile network. The device is applied to a sensing application function network element. The device includes:
a registration request reception module, configured to receive a registration request from a sensing entity, where the registration request includes a type of the sensing entity and a capability of the sensing entity, and the sensing application function network element is configured to provide a sensing service for the sensing entity;
an information transmission module, configured to transmit a sensing registration accept message to the sensing entity, and transmit a sensing request to the sensing entity; and
a response message reception module, configured to receive a sensing response message from the sensing entity.

A fifth aspect of embodiments of the present disclosure provides a sensing entity. The sensing entity includes:
one or more first processors;
a first memory that stores first processor-executable instructions.

The one or more first processors are collectively configured to perform the sensing method for a mobile network according to the first aspect of the present disclosure by executing the first processor-executable instructions.

A sixth aspect of embodiments of the present disclosure provides a sensing application function network element. The sensing application function network element includes:
one or more second processors; and
a second memory that stores second processor-executable instructions.

The one or more second processors are collectively configured to perform the sensing method for a mobile network according to the second aspect of the present disclosure by executing the second processor-executable instructions.

A seventh aspect of embodiments of the present disclosure provides a non-transitory computer-readable storage medium. The non-transitory computer-readable storage medium stores computer program instructions. The computer program instructions, when executed by a processor, implement steps of the sensing method for a mobile network according to the first aspect or the second aspect of the present disclosure.

### BRIEF DESCRIPTION OF DRAWINGS

The above and/or additional aspects and advantages of the present disclosure will become obvious and comprehensible from the description of embodiments in conjunction with the drawings.

FIG. 1 is a schematic diagram of a network architecture for a method provided by an embodiment of the present disclosure.

FIG. 2 is a flowchart of a sensing method for a mobile network according to some embodiments.

FIG. 3 is a schematic diagram of a network architecture including a sensing application function (SAF) for a sensing method for a mobile network according to some embodiments.

FIG. 4 is a communication sequence chart of a sensing method for a mobile network according to some embodiments.

FIG. 5 is a flowchart of a sensing method for a mobile network according to some other embodiments.

FIG. 6 is a schematic diagram of a network architecture for a sensing method for a mobile network according to some other embodiments, where a wireless access point in this network architecture is provided by an untrusted non-3rd generation partnership project (3GPP).

FIG. 7 is a schematic diagram of a network architecture for a sensing method for a mobile network according to some other embodiments, where a wireless access point in this network architecture is provided by a trusted non-3GPP.

FIG. 8 is a communication sequence chart of a sensing method for a mobile network according to some other embodiments.

FIG. 9 is a flowchart of a sensing method for a mobile network according to some another embodiments.

FIG. 10 is a communication sequence chart of a sensing method for a mobile network according to some another embodiments.

FIG. 11 is a flowchart of a sensing method for a mobile network according to some another embodiments.

FIG. 12 is a communication sequence chart of a sensing method for a mobile network according to some another embodiments.

FIG. 13 is a flowchart of a sensing method for a mobile network according to some another embodiments.

FIG. 14 is a communication sequence chart of a sensing method for a mobile network according to some another embodiments.

FIG. 15 is a flowchart of a sensing method for a mobile network according to some another embodiments.

FIG. 16 is a communication sequence chart of a sensing method for a mobile network according to some another embodiments.

FIG. 17 is a flowchart of a sensing method for a mobile network according to some other embodiments.

FIG. 18 is a communication sequence chart of a sensing method for a mobile network according to some other embodiments.

FIG. 19 is a flowchart of a sensing method for a mobile network according to some embodiments.

FIG. 20 is a block diagram of a sensing device for a mobile network according to some embodiments.

FIG. 21 is a block diagram of a sensing device for a mobile network according to some embodiments.

FIG. 22 is a block diagram of a sensing entity according to some embodiments.

FIG. 23 is a block diagram of a sensing application function network element according to some embodiments.

### DETAILED DESCRIPTION OF THE INVENTION

Examples will be described in detail and the instances are shown in the accompanying drawings illustratively. When the following description involves the accompanying drawings, unless otherwise specified, an identical number in different accompanying drawings denotes identical or similar elements. Implementations described in the following examples do not denote all implementations consistent with the present disclosure. On the contrary, the implementations are merely instances of a device and a method consistent with some aspects of the present disclosure as detailed in the appended claims.

FIG. 1 is a schematic diagram of a network architecture for a method provided by an embodiment of the present disclosure. The network architecture may include the following network elements 1) to 6).

### 1) User Equipment 101

The user equipment 101 includes a device providing at least one of voice or data connectivity for a user. For example, the user equipment 101 includes a device providing voice for a user, a device providing data connectivity for a user, or a device providing voice and data connectivity for a user. For instance, the user equipment may include a handheld device having a radio connection function, or a processing device connected to a radio modem. As an implementation, the user equipment 101 may be a mobile station (MS), a mobile terminal (MT), etc.

For example, the user equipment 101 may be a mobile phone, a tablet computer, a computer having a radio transceiving function, a virtual reality (VR) terminal, an augmented reality (AR) terminal, a radio terminal in industrial control, a radio terminal in self-driving, a radio terminal in telemedicine, a radio terminal in smart grid, a radio terminal in smart city, a smart home, an in-vehicle terminal, etc.

### 2) Access Network (AN) 102

The access network may provide a network access function for an authorized user in a specific zone, and may use transmission tunnels different in quality according to user levels and business requirements. The access network may be an access network using different access technologies. At present, there are two types of wireless access technologies: a 3rd generation partnership project (3GPP) access technology (for instance, a radio access technology used in a 3rd generation (3G), 4th generation (4G) or 5th generation (5G) system) and a non-3rd generation partnership project (non-3GPP) access technology.

The 3GPP access technology refers to an access technology conforming to a 3GPP standard. The access network using the 3GPP access technology is referred to as a radio access network (RAN). An access network device in the 5G system is referred to as a next generation node base station (gNB). The non-3GPP access technology refers to an access technology that does not conform to the 3GPP standard, and for instance, an air interface technology represented by an access point (AP) in wireless fidelity (Wi-Fi).

An access network that achieves an access network function based on wireless communication technology may be referred to as a radio access network (RAN). The radio access network is capable of managing a radio resource, providing an access service for user equipment, and further performing forwarding of a control signal and user data between the user equipment and a core network.

### 3) Access and Mobility Management Function (AMF) Entity 103

The AMF entity is mainly configured for mobility management, access management, etc., and may be configured to implement functions other than session management of a mobility management entity (MME), such as lawful interception or access authorization (or authentication), etc.

### 4) Session Management Function (SMF) Entity 104

The SMF entity is mainly configured for session management, Internet protocol (IP) address allocation and management of the UE, selection of a manageable user plane function, policy control, an endpoint of a charging function interface, and downlink data notification.

### 5) User Plane Function (UPF) Entity 106

The UPF, also referred to as a data plane gateway, may be configured for packet routing and forwarding, quality of service (QOS) processing of user plane data, etc. User data may access a data network (DN) through the network element.

### 6) Non-3GPP Inter Working Function (N3IWF) 105

The N3IWF is responsible for connecting an untrusted non-3GPP access network (such as Wi-Fi) to a 5G core network. The UE establishes an Internet protocol security (IPsec) tunnel with the N3IWF. The N3IWF accesses a control plane and a user plane of the 5G core network through an N2 interface and an N3 interface respectively.

In the network architecture, an NI interface is a reference point between the user equipment and the AMF entity; an N2 interface is a reference point between the N3IWF and the AMF entity; an N3 interface is a reference point between the N3IWF and the UPF entity; an N4 interface is a reference point between the SMF entity and the UPF entity; and an N11 interface is a reference point between the AMF entity and the SMF entity.

In the embodiments of the present disclosure, the user equipment 101 and an access network 102 may be collectively referred to as a sensing entity 10. That is, the sensing entity 10 may include at least one of the user equipment 101 or the access network 102. The access network 102 may include a wireless access point (AP). The wireless access point may include Wi-Fi, radar, etc.

It is to be understood that the network architecture applied to the embodiments of the present disclosure is only an illustrative network architecture described from perspectives of a traditional point-to-point structure and a service structure, and does not limit the network architecture applicable to the embodiments of the present disclosure. Any network architecture that can achieve functions of all the network elements is applicable to the embodiments of the present disclosure.

It is also to be understood that the AMF entity, the SMF entity, the UPF entity, etc. shown in FIG. 1 may be understood as network elements configured for achieving different functions in the core network, and for instance, may be combined into network slices as required. The network elements of the core network may be independent devices or integrated into a same device, so as to achieve different functions, which is not limited in the present disclosure.

It is to be understood that the names are used for distinguishing different functions, and do not indicate that the network elements are independent physical devices respectively. The present disclosure does not limit forms of the network elements, and for instance, the network elements may be integrated in a same physical device or may be different physical devices respectively. In addition, the names are used for distinguishing different functions, and are not limited the present disclosure. The present disclosure does not rule out a possibility of using other names in the 5G network and other networks in the future. For instance, in a 6G network, some or all the network elements may follow terminology in 5G, or may use other names. The terms are explained in a unified way, and will not be repeated.

It is to be understood that a name of an interface between the network elements in FIG. 1 is only illustrative, and a name of an interface may be another name in an example, and is not limited in the present disclosure.

At present, there is no sensing solution for a mobile network.

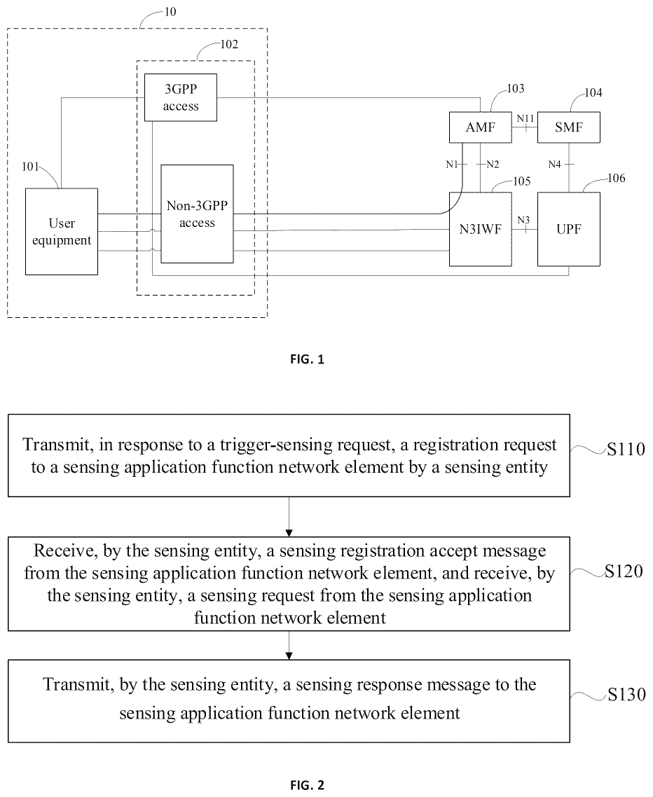

FIG. 2 is a flowchart of a sensing method for a mobile network according to some embodiments. As shown in FIG. 2, the sensing method for a mobile network may be performed by a sensing entity 10 in FIG. 1. The method includes the following steps S110 to S130.

In S110, in response to a trigger-sensing request, a registration request is transmitted to a sensing application function network element by the sensing entity.

In the embodiment of the present disclosure, the sensing entity may include at least one of user equipment (UE) or a wireless access point (AP). For example, the sensing entity may include the user equipment (UE), the wireless access point (AP), or the user equipment (UE) and the wireless access point (AP).

In some implementations, in response to the trigger-sensing request, the registration request may be transmitted to the sensing application function network element by the sensing entity. The sensing request may be triggered in a case where a power-on state of the user equipment is detected, or the sensing request may be triggered in a case where a power-on state of the wireless access point is detected. In some examples, the sensing request may also be triggered in a case where detecting that a designated application on the user equipment is authorized to be opened. The designated application may be capable of sensing capability.

It is to be noted that the sensing entity may include one user equipment and one wireless access point. The sensing entity may also include one user equipment and a plurality of wireless access points. The sensing entity may also include a plurality of user equipment and one wireless access point. Alternatively, the sensing entity may also include a plurality of user equipment and a plurality of wireless access points. Devices, a number of user equipment and a number of wireless access points included in the sensing entity are not limited, and may be selected according to actual cases.

In some examples, in a case where detecting the trigger-sensing request, the sensing entity may transmit the registration request to the sensing application function (SAF) network element. The sensing application function (SAF) network element may be configured to provide a sensing service for the sensing entity. The sensing application function (SAF) network element is similar to an N3IWF network element, a UPF network element, an AMF network element, an SMF network element, etc., all of these are the network elements defined by the 3GPP. In other words, the sensing application function (SAF) network element may belong to the 3GPP core network.

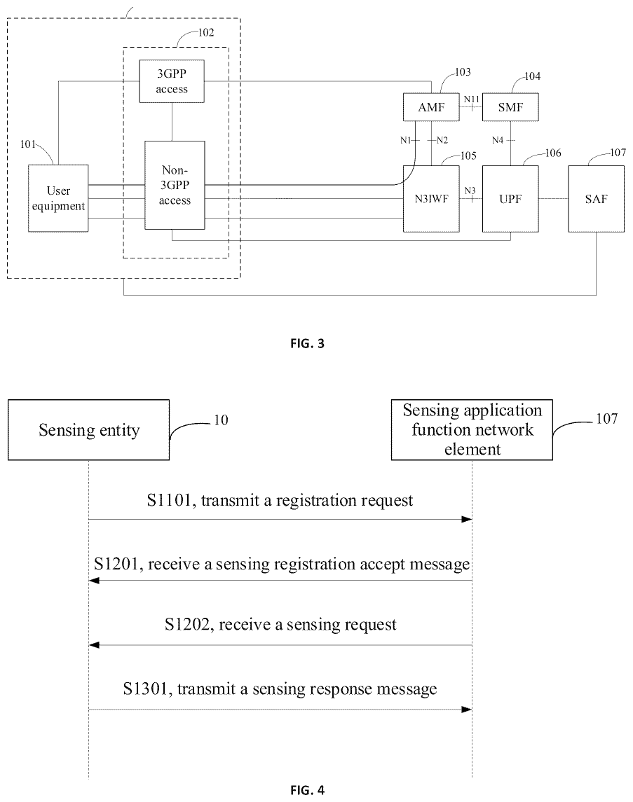

In order to better understand a relation between the sensing application function (SAF) network element and the sensing entity, the embodiment of the present disclosure provides a schematic diagram of a network architecture including the sensing application function (SAF) network element as shown in FIG. 3. In FIG. 3, the sensing entity 10 may be connected to the sensing application function (SAF) network element 107 in a wired/wireless manner, that is, the sensing entity 10 and the sensing application function (SAF) network element 107 may transmit data to each other. In addition, the sensing application function (SAF) network element 107 may have a connection relation with the UPF network element 106. It should be noted that the embodiment of the present disclosure may pre-configure an SAF on the sensing entity before starting a registration procedure.

In some implementations, the registration request may include a type of the sensing entity and a capability of the sensing entity. The types of the sensing entity may include the user equipment and the wireless access point. The user equipment may be replaced with a terminal.

In addition, the capability of the sensing entity includes at least one of: a Wi-Fi capable sensing; supporting at least one of transmitter or receiver; a sensing range of at least one of the transmitter or the receiver; a supported radio frequency; or sensing accuracy. In other words, in a case where the registration request is transmitted to the sensing application function network element, the sensing entity may indicate whether the sensing entity has the Wi-Fi capable sensing, whether at least one of the transmitter or the receiver is supported, the sensing range of at least one of the supported transmitter or supported receiver, a range of the supported radio frequency, and a sensing accuracy range during sensing.

In some other implementations, the registration request may include at least one of an identifier of the sensing entity or a location of the sensing entity. The identifier of the sensing entity includes at least one of: a generic public subscription identifier (GPSI) of the user equipment; a basic service set identifier (BSSID) of the Wi-Fi; or a media access control (MAC) address. In addition, the location of the sensing entity may include longitude information and latitude information.

In S120, a sensing registration accept message is received from the sensing application function network element by the sensing entity, and a sensing request is received from the sensing application function network element.

In some examples, after transmitting the registration request to the sensing application function network element, the sensing entity may receive the sensing registration accept message from the sensing application function network element. The sensing registration accept message may notify the sensing entity whether the sensing entity may serve as a transmitter/a receiver. That is, in a case where the sensing entity receives the sensing registration accept message from the sensing application function network element, the sensing entity may be determined that the sensing entity is successfully registered.

In addition, the sensing registration accept message may be a message transmitted by the sensing application function network element, after the sensing application function network element receives the registration request transmitted by the sensing entity and selects, according to requirements of the sensing entity, the transmitter/the receiver.

In some examples, the sensing registration accept message may include a data transmission requirement. The data transmission requirement is configured to indicate how the sensing entity transmits data to the sensing application function network element, a frequency point at which the data is transmitted, a waveform of the transmitted data, a transmission power, etc. After receiving the sensing registration accept message, the sensing entity may transmit data to the sensing application function network element based on the data transmission requirement in the sensing registration accept message.

In some other implementations, after receiving the sensing registration accept message from the sensing application function network element, the sensing entity may receive the sensing request from the sensing application function network element. The sensing request may be a sensing start instruction. In other words, the sensing request may be configured to indicate the sensing entity to start a sensing operation.

It is to be noted that the sensing registration accept message may be transmitted to the sensing entity before the sensing request, the sensing registration accept message may also be transmitted to the sensing entity together with the sensing request.

In S130, a sensing response message is transmitted to the sensing application function network element by the sensing entity.

In some examples, after receiving the sensing request from the sensing application function network element, the sensing entity may transmit the sensing response message to the sensing application function network element, such that the sensing entity may notify, through the sensing response message, the sensing application function network element that the sensing entity may start to transmit and receive data.

FIG. 4 is a communication sequence chart of a sensing method for a mobile network according to some embodiments. As shown in FIG. 4, the sensing entity 10 may transmit (S1101) the registration request to the sensing application function network element 107. The sensing application function network element 107 may transmit (S1201) the sensing registration accept message to the sensing entity 10 after receiving the registration request. The sensing entity 10 may receive (S1202) the sensing request transmitted by the sensing application function network element 107 and transmit (S1301) the sensing response message to the sensing application function network element 107.

In the embodiments of the present disclosure, in response to the trigger-sensing request, the registration request may be transmitted to the sensing application function network element by the sensing entity, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element.

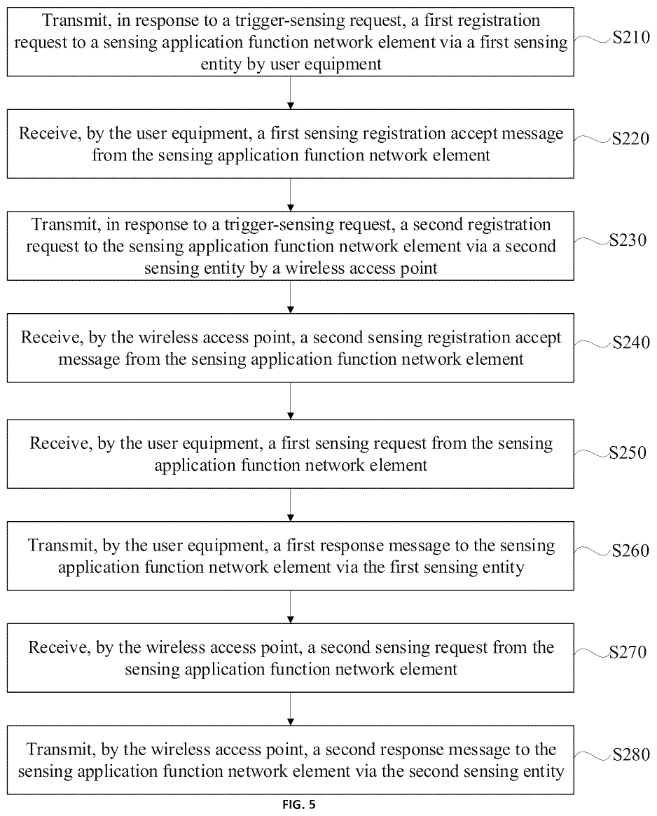

FIG. 5 is a flowchart of a sensing method for a mobile network according to some other embodiments. As shown in FIG. 5, the sensing method for a mobile network may be performed by the sensing entity in FIG. 1. The method may include the following steps S210 to S280.

In S210, in response to a trigger-sensing request, a first registration request is transmitted to a sensing application function network element via a first sensing entity by user equipment.

In some implementations, the user equipment may include the first sensing entity, and a wireless access point may include a second sensing entity. The first sensing entity may be a transmitter, and the second sensing entity may be a receiver. Thus, in the embodiment of the present disclosure, in response to the trigger-sensing request, the first registration request may be transmitted to the sensing application function network element via the first sensing entity by the user equipment.

In the embodiment of the present disclosure, the first registration request may be configured to indicate that a type of the sensing entity is the user equipment. Further, the first registration request may be configured to indicate that the first sensing entity has a capability of the transmitter.

In S220, a first sensing registration accept message is received from the sensing application function network element by the user equipment.

In some implementations, the first sensing registration accept message may be received from the sensing application function network element by the user equipment. The first sensing registration accept message is configured to indicate that the first sensing entity is the transmitter, that is, the first sensing registration accept message is configured to indicate that the user equipment is successfully registered as the transmitter.

In S230, in response to the trigger-sensing request, a second registration request is transmitted to the sensing application function network element via the second sensing entity by the wireless access point.

In some examples, in response to the trigger-sensing request, the second registration request may be transmitted to the sensing application function network element via the second sensing entity by the wireless access point. The second registration request is configured to indicate that the type of the sensing entity is the wireless access point. The second registration request is configured to indicate that the second sensing entity has a capability of the receiver.

It is to be noted that the first registration request may be transmitted to the sensing application function network element via the first sensing entity by the user equipment, and then the second registration request may be transmitted to the sensing application function network element via the second sensing entity by the wireless access point. In some examples, the second registration request may be transmitted to the sensing application function network element via the second sensing entity by the wireless access point, and then the first registration request may be transmitted to the sensing application function network element via the first sensing entity by the user equipment. In some examples, the second registration request may be transmitted to the sensing application function network element via the second sensing entity by the wireless access point while the first registration request may be transmitted to the sensing application function network element via the first sensing entity by the user equipment. For example, whether to transmit the first registration request or the second registration request first is not limited and may be selected according to own cases.

For example, before transmitting the registration request, the user equipment and the wireless access point may establish a connection to each other and transmit respective capabilities based on the connection. For instance, the user equipment may notify the wireless access point that the user equipment is the transmitter. For another instance, the wireless access point notifies the user equipment that the wireless access point is the receiver. In this way, mobile network sensing may be implemented more simply and effectively.

In S240, a second sensing registration accept message is received from the sensing application function network element by the wireless access point.

In some implementations, the second sensing registration accept message may be received from the sensing application function network element by the wireless access point. The second sensing registration accept message is configured to indicate that the second sensing entity is the receiver, that is, the second sensing registration accept message is configured to indicate that the wireless access point is successfully registered as the receiver.

In S250, a first sensing request is received from the sensing application function network element by the user equipment.

In some implementations, after the first sensing registration accept message is received from the sensing application function network element by the user equipment, the user equipment may receive the first sensing request from the sensing application function network element. The first sensing request is configured to indicate the first sensing entity to start to transmit data. That is, the first sensing request notifies the user equipment that data may start to be transmitted.

In S260, a first response message is transmitted to the sensing application function network element via the first sensing entity by the user equipment.

In some examples, after receiving the first sensing request, the user equipment may transmit the first response message to the sensing application function network element via the first sensing entity. The first response message includes confirmation for data transmission, so as to notify, according to the first response message, the sensing application function network element that the user equipment is ready to start to transmit the data.

In S270, a second sensing request is received from the sensing application function network element by the wireless access point.

In some implementations, after the second sensing registration accept message is received from the sensing application function network element by the wireless access point, the wireless access point may receive the second sensing request from the sensing application function network element. The second sensing request is configured to indicate the second sensing entity to start to receive data, that is, the second sensing request notifies the wireless access point that data may start to be received.

In S280, a second response message is transmitted to the sensing application function network element via the second sensing entity by the wireless access point.

In some examples, after receiving the second sensing request, the wireless access point may transmit the second response message to the sensing application function network element via the second sensing entity. The second response message includes at least one of sensing measurement data or a sensing measurement result. In addition, the second response message may include a confirm message, such that the sensing application function network element is notified through the second response message that the wireless access point is ready to start to receive data. Meanwhile, the sensing measurement data received by the wireless access point may be transmitted to the sensing application function network element, such that the sensing application function network element may be instructed to analyze the sensing measurement data transmitted by the wireless access point. In addition, the wireless access point may also analyze received data so as to obtain a sensing measurement result, and transmit the sensing measurement result to the sensing application function network element.

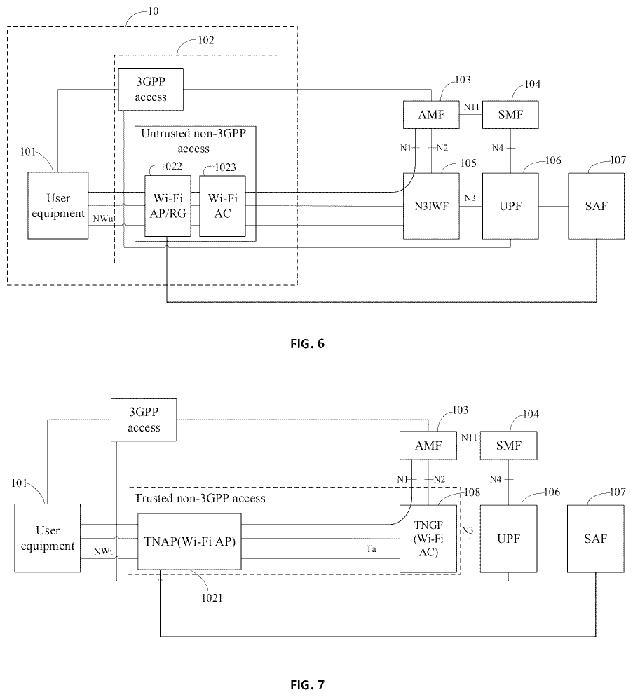

In the embodiment of the present disclosure, the wireless access point may be provided by a trusted non-3GPP or provided by an untrusted non-3GPP. A schematic diagram of a network architecture may be as shown in FIGS. 6 and 7. The wireless access point in FIG. 6 may be provided by the untrusted non-3GPP. It is seen from FIG. 6 that the untrusted non-3GPP may include the wireless access point (AP). The wireless access point may be a Wi-Fi AP 1022. A residential gateway (RG) may be configured to replace the wireless access point (AP). In addition, the wireless access point (AP) may be connected to the sensing application function (SAF) network element, such that data transmission is facilitated.

In some implementations, the non-3GPP may include Wi-Fi. In some examples, the non-3GPP may include devices related to a radio technology such as radar. In addition, it is seen from FIG. 6 that the untrusted non-3GPP may include a Wi-Fi access controller (AC) 1023.

The wireless access point in FIG. 7 may be provided by a trusted 3GPP. It is seen from FIG. 7 that trusted non-3GPP access may include the wireless access point (AP). The wireless access point may be a Wi-Fi AP. A residential gateway (RG) may be configured to replace the wireless access point (AP). In addition, the access point in the trusted non-3GPP access may be a trusted non-3GPP access point (TNAP) 1021. In some examples, the trusted non-3GPP access may include a trusted non-3GPP functional network element (TNGF) 108.

In conclusion, in the embodiment of the present disclosure, the user equipment may be used as a transmitter, and the wireless access point may be used as a receiver.

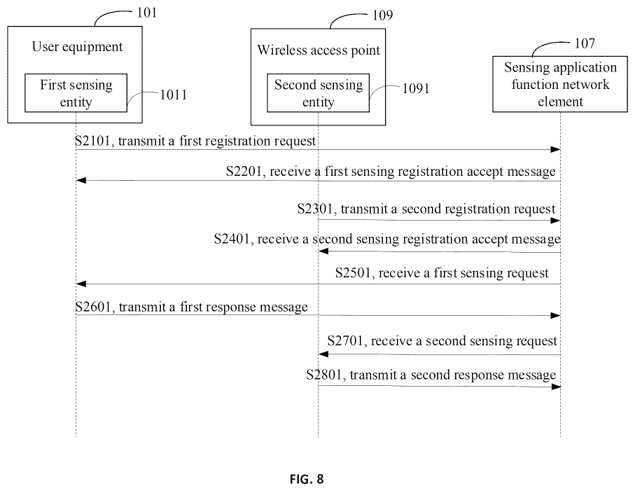

FIG. 8 is a communication sequence chart of a sensing method for a mobile network according to some embodiments. As shown in FIG. 8, a first registration request may be transmitted (S2101) to a sensing application function network element 107 by a first sensing entity 1011 of user equipment 101. A first sensing registration accept message may be transmitted (S2201) to the user equipment 101 including the first sensing entity 1011 by the sensing application function network element 107. Meanwhile, a second registration request may be transmitted (S2301) to the sensing application function network element 107 by a second sensing entity 1091 of a wireless access point 109. A second sensing registration accept message may be transmitted (S2401) to the wireless access point 109 including the second sensing entity 1091 by the sensing application function network element 107. Based on this, in response to a first sensing request transmitted (S2501) by the sensing application function network element 107, the first sensing entity 1011 of the user equipment 101 may transmit (S2601) a first response message to the sensing application function network element 107. Meanwhile, in response to a second sensing request transmitted (S2701) by the sensing application function network element 107, the second sensing entity 1091 of the wireless access point 109 may transmit (S2801) a second response message to the sensing application function network element 107.

In the embodiments of the present disclosure, in response to the trigger-sensing request, the registration request may be transmitted to the sensing application function network element by the user equipment, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element. In addition, the embodiment of the present disclosure may combine a 3GPP network with a Wi-Fi network, and further provide a sensing-based service. Through the mobile network and radio interface Wi-Fi, an operator may provide a responsive sensing service, and further network sensing may be conducted more conveniently.

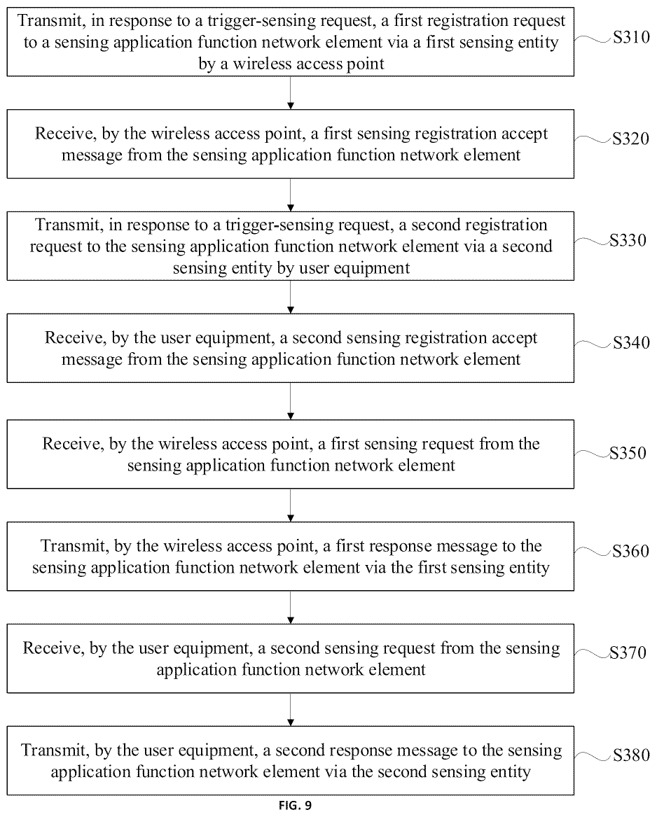

FIG. 9 is a flowchart of a sensing method for a mobile network according to some another embodiments. As shown in FIG. 9, the sensing method for a mobile network may be performed by the sensing entity in FIG. 1. The method may include the following steps S310 to S380.

In S310, in response to a trigger-sensing request, a first registration request is transmitted to a sensing application function network element via a first sensing entity by a wireless access point.

In the embodiment of the present disclosure, the wireless access point may include the first sensing entity, and user equipment may include a second sensing entity. The first sensing entity may be a transmitter, and the second sensing entity may be a receiver. Thus, in the embodiment of the present disclosure, in response to the trigger-sensing request, the first registration request may be transmitted to the sensing application function network element via the first sensing entity by the wireless access point.

In the embodiment of the present disclosure, the first registration request may be configured to indicate that a type of the sensing entity is the wireless access point and the first registration request may be configured to indicate that the first sensing entity has a capability of the transmitter.

In S320, a first sensing registration accept message is received from the sensing application function network element by the wireless access point.

In some implementations, the first sensing registration accept message may be received from the sensing application function network element by the wireless access point. The first sensing registration accept message is configured to indicate that the first sensing entity is the transmitter, that is, the first sensing registration accept message is configured to indicate that the wireless access point is successfully registered as the transmitter.

In S330, in response to the trigger-sensing request, a second registration request is transmitted to the sensing application function network element via the second sensing entity by the user equipment.

In some examples, in response to the trigger-sensing request, the second registration request may be transmitted to the sensing application function network element via the second sensing entity by the user equipment. The second registration request is configured to indicate that the type of the sensing entity is the user equipment and the second registration request is configured to indicate that the second sensing entity has a capability of the receiver. Reference may be made to introduction of the embodiment for the first registration request and the second registration request.

In S340, a second sensing registration accept message is received from the sensing application function network element by the user equipment.

In some implementations, the second sensing registration accept message may be received from the sensing application function network element by the user equipment. The second sensing registration accept message is configured to indicate that the second sensing entity is the receiver, that is, the second sensing registration accept message is configured to indicate that the user equipment is successfully registered as the receiver.

In S350, a first sensing request is received from the sensing application function network element by the wireless access point.

In some implementations, after the first sensing registration accept message is received from the sensing application function network element by the wireless access point, the wireless access point may receive the first sensing request from the sensing application function network element. The first sensing request is configured to indicate the first sensing entity to start to transmit data, that is, the first sensing request notifies the wireless access point that data may start to be transmitted.

In S360, a first response message is transmitted to the sensing application function network element via the first sensing entity by the wireless access point.

In some examples, after receiving the first sensing request, the wireless access point may transmit the first response message to the sensing application function network element via the first sensing entity. The first response message includes confirmation for data transmission, such that the sensing application function network element is notified through the first response message that the wireless access point is ready to start to transmit the data.

In S370, a second sensing request is received from the sensing application function network element by the user equipment.

In some implementations, after the second sensing registration accept message is received from the sensing application function network element by the user equipment, the user equipment may receive the second sensing request from the sensing application function network element. The second sensing request is configured to indicate the second sensing entity to start to receive data, that is, the second sensing request notifies the user equipment that data may start to be received.

In S380, a second response message is transmitted to the sensing application function network element via the second sensing entity by the user equipment.

In some examples, after receiving the second sensing request, the user equipment may transmit the second response message to the sensing application function network element through the second sensing entity. The second response message includes at least one of sensing measurement data or a sensing measurement result.

In conclusion, in the embodiment of the present disclosure, the wireless access point may be used as a transmitter, and the user equipment may be used as a receiver.

The implementation solution, identical to the embodiment, of the embodiment of the present disclosure will not be repeated. Reference may be made to introduction of the embodiment for details.

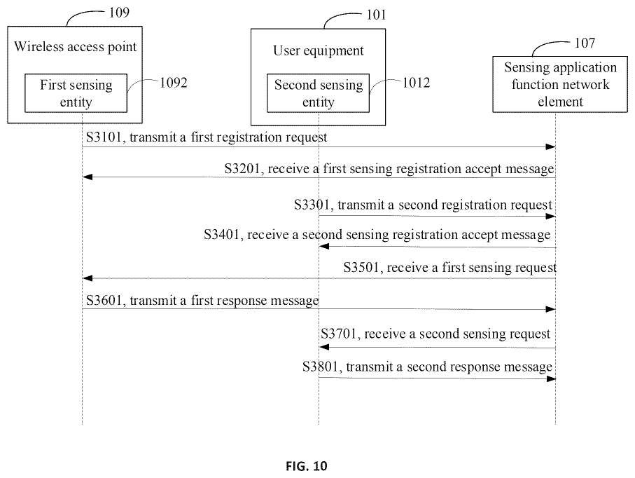

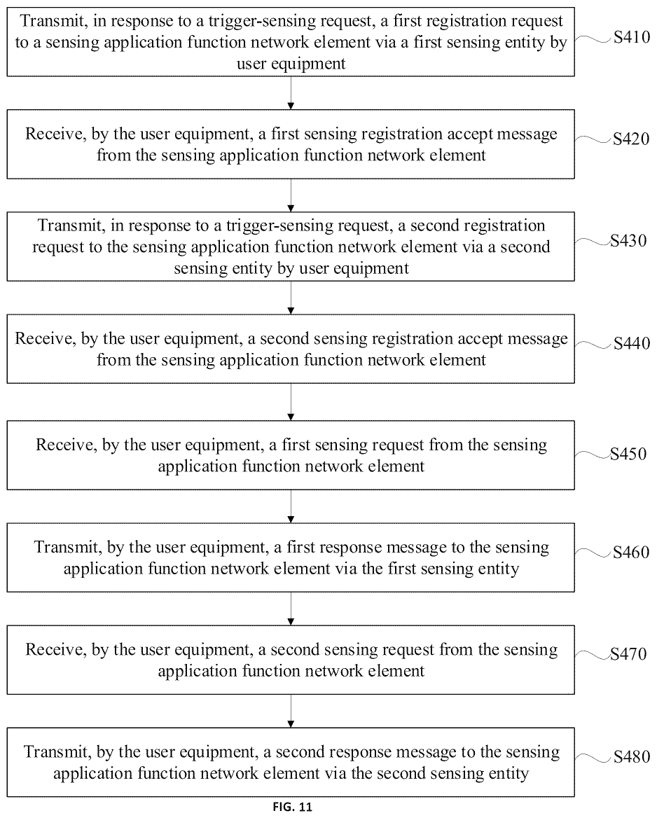

FIG. 10 is a communication sequence chart of a sensing method for a mobile network according to some another embodiments. As shown in FIG. 10, a first registration request may be transmitted (S1301) to a sensing application function network element 107 by a first sensing entity 1092 of a wireless access point 109. Further, a first sensing registration accept message may be transmitted (S3201) to the wireless access point 109 including the first sensing entity 1092 by the sensing application function network element 107. Meanwhile, a second registration request may be transmitted (S3301) to the sensing application function network element 107 by a second sensing entity 1012 of the user equipment 101. A second sensing registration accept message may be transmitted (S3401) to the user equipment 101 including the second sensing entity 1012 by the sensing application function network element 107. Based on this, in response to a first sensing request transmitted (S3501) by the sensing application function network element 107, the first sensing entity 1092 of the wireless access point 109 may transmit (S3601) a first response message to the sensing application function network element 107. Meanwhile, in response to a second sensing request transmitted (S3701) by the sensing application function network element 107, the second sensing entity 1092 of the user equipment 109 may transmit (S3801) a second response message to the sensing application function network element 107.

In the embodiments of the present disclosure, in response to the trigger-sensing request, the registration request may be transmitted to the sensing application function network element by the wireless access point, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element. In addition, the embodiment of the present disclosure may combine a 3GPP network with a Wi-Fi network, and further provide a sensing-based service. Through the mobile network and radio interface Wi-Fi, an operator may provide a responsive sensing service, and further network sensing may be conducted more conveniently.

FIG. 11 is a flowchart of a sensing method for a mobile network according to some another embodiments. As shown in FIG. 11, the sensing method for a mobile network may be performed by the sensing entity in FIG. 1. The method may include the following steps S410 to S480.

In S410, in response to a trigger-sensing request, a first registration request is transmitted to a sensing application function network element via a first sensing entity by user equipment.

In the embodiment of the present disclosure, the user equipment may include a second sensing entity and the first sensing entity. The first sensing entity may be a transmitter, and the second sensing entity may be a receiver. Thus, in the embodiment of the present disclosure, in response to the trigger-sensing request, the first registration request is transmitted to the sensing application function network element via the first sensing entity by the user equipment.

In the embodiment of the present disclosure, the first registration request may be configured to indicate that a type of the sensing entity is the user equipment and the first registration request may be configured to indicate that the first sensing entity has a capability of the transmitter.

In S420, a first sensing registration accept message is received from the sensing application function network element by the user equipment.

In some implementations, the first sensing registration accept message may be received from the sensing application function network element by the user equipment. The first sensing registration accept message is configured to indicate that the first sensing entity is the transmitter, that is, the first sensing registration accept message is configured to indicate that the user equipment is successfully registered as the transmitter.

In S430, in response to the trigger-sensing request, a second registration request is transmitted to the sensing application function network element via the second sensing entity by the user equipment.

In some examples, in response to the trigger-sensing request, the second registration request may be transmitted to the sensing application function network element via the second sensing entity by the user equipment. The second registration request is configured to indicate that the type of the sensing entity is the user equipment and the second registration request is configured to indicate that the second sensing entity has a capability of the receiver. Reference may be made to introduction of the embodiment for the first registration request and the second registration request.

In S440, a second sensing registration accept message is received from the sensing application function network element by the user equipment.

In some implementations, the second sensing registration accept message may be received from the sensing application function network element by the user equipment. The second sensing registration accept message is configured to indicate that the second sensing entity is the receiver, that is, the second sensing registration accept message is configured to indicate that the user equipment is successfully registered as the receiver.

In S450, a first sensing request is received from the sensing application function network element by the user equipment.

In some implementations, after the first sensing registration accept message is received from the sensing application function network element by the user equipment, the user equipment may receive the first sensing request from the sensing application function network element. The first sensing request is configured to indicate the first sensing entity to start to transmit data. That is, the first sensing request notifies the user equipment that data may start to be transmitted.

In S460, a first response message is transmitted to the sensing application function network element via the first sensing entity by the user equipment.

In some examples, after receiving the first sensing request, the user equipment may transmit the first response message to the sensing application function network element via the first sensing entity. The first response message includes confirmation for data transmission, such that the sensing application function network element is notified through the first response message that the user equipment is ready to start to transmit the data.

In S470, a second sensing request is received from the sensing application function network element by the user equipment.

In some implementations, after the second sensing registration accept message is received from the sensing application function network element by the user equipment, the user equipment may receive the second sensing request from the sensing application function network element. The second sensing request is configured to indicate the second sensing entity to start to receive data. That is, the second sensing request notifies the user equipment that data may start to be received.

In S480, a second response message is transmitted to the sensing application function network element via the second sensing entity by the user equipment.

In some examples, after receiving the second sensing request, the user equipment may transmit the second response message to the sensing application function network element via the second sensing entity. The second response message includes at least one of sensing measurement data or a sensing measurement result.

In conclusion, in the embodiment of the present disclosure, the user equipment may be used as a transmitter or a receiver.

The implementation solution, identical to the embodiment, of the embodiment of the present disclosure will not be repeated. Reference may be made to introduction of the embodiment for details.

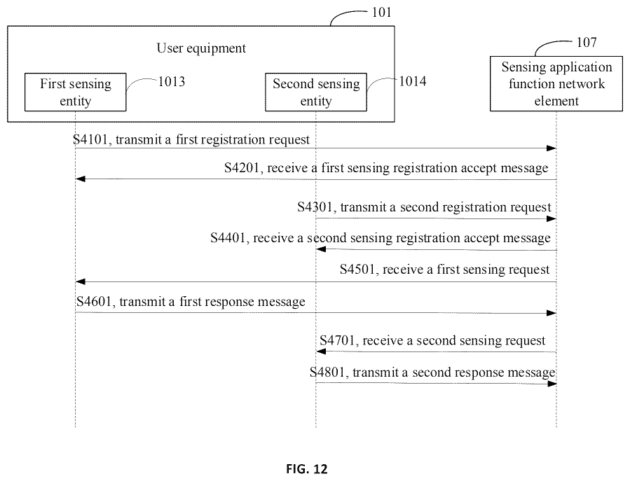

FIG. 12 is a communication sequence chart of a sensing method for a mobile network according to some another embodiments. As shown in FIG. 12, a first registration request may be transmitted (S4101) to a sensing application function network element 107 by a first sensing entity 1013 of user equipment 101. Further, a first sensing registration accept message may be transmitted (S4201) to the user equipment 101 including the first sensing entity 1013 by the sensing application function network element 107. Meanwhile, a second registration request may be transmitted (S4301) to the sensing application function network element 107 by a second sensing entity 1014 of the user equipment 101. A second sensing registration accept message may be transmitted (S4401) to the user equipment 101 including the second sensing entity 1014 by the sensing application function network element 107. Based on this, in response to a first sensing request transmitted (S4501) by the sensing application function network element 107, the first sensing entity 1013 of the user equipment 101 may transmit (S4601) a first response message to the sensing application function network element 107. Meanwhile, in response to a second sensing request transmitted (S4701) by the sensing application function network element 107, the second sensing entity 1014 of the user equipment 101 may transmit (S4801) a second response message to the sensing application function network element 107.

In the embodiments of the present disclosure, in response to the trigger-sensing request, the registration request may be transmitted to the sensing application function network element by the user equipment, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element. In addition, the embodiment of the present disclosure may combine a 3GPP network with a Wi-Fi network, and further provide a sensing-based service. Through the mobile network and radio interface Wi-Fi, an operator may provide a responsive sensing service, and further network sensing may be conducted more conveniently.

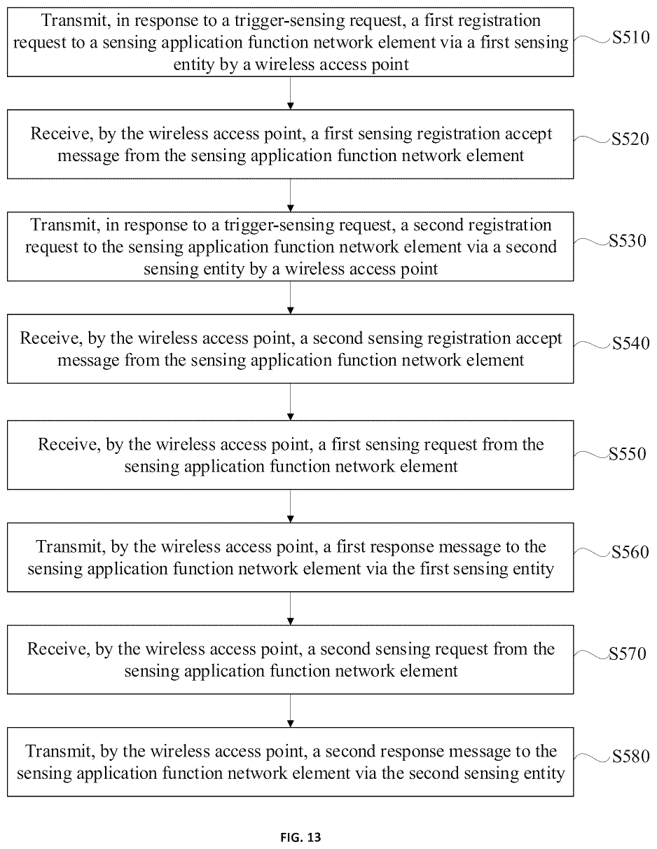

FIG. 13 is a flowchart of a sensing method for a mobile network according to some another embodiments. As shown in FIG. 13, the sensing method for a mobile network may be performed by the sensing entity in FIG. 1. The method may include the following steps S510-S580.

In S510, in response to a trigger-sensing request, a first registration request is transmitted to a sensing application function network element via a first sensing entity by a wireless access point.

In the embodiment of the present disclosure, the wireless access point may include a second sensing entity and the first sensing entity. The first sensing entity may be a transmitter, and the second sensing entity may be a receiver. Thus, in the embodiment of the present disclosure, in response to the trigger-sensing request, the first registration request may be transmitted to the sensing application function network element via the first sensing entity by the wireless access point.

In the embodiment of the present disclosure, the first registration request may be configured to indicate that a type of the sensing entity is the wireless access point and the first registration request may be configured to indicate that the first sensing entity has a capability of the transmitter.

In S520, a first sensing registration accept message is received from the sensing application function network element by the wireless access point.

In some implementations, the first sensing registration accept message may be received from the sensing application function network element by the wireless access point. The first sensing registration accept message is configured to indicate that the first sensing entity is the transmitter, that is, the first sensing registration accept message is configured to indicate that the wireless access point is successfully registered as the transmitter.

In S530, in response to the trigger-sensing request, a second registration request is transmitted to the sensing application function network element via the second sensing entity by the wireless access point.

In some examples, in response to the trigger-sensing request, the second registration request may be transmitted to the sensing application function network element via the second sensing entity by the wireless access point. The second registration request is configured to indicate that the type of the sensing entity is the wireless access point and the second registration request is configured to indicate that the second sensing entity has a capability of the receiver. Reference may be made to introduction of the embodiment for the first registration request and the second registration request.

In S540, a second sensing registration accept message is received from the sensing application function network element by the wireless access point.

In some implementations, the second sensing registration accept message may be received from the sensing application function network element by the wireless access point. The second sensing registration accept message is configured to indicate that the second sensing entity is the receiver, that is, the second sensing registration accept message is configured to indicate that the wireless access point is successfully registered as the receiver.

In S550, a first sensing request is received from the sensing application function network element by the wireless access point.

In some implementations, after the first sensing registration accept message is received from the sensing application function network element by the wireless access point, the wireless access point may receive the first sensing request from the sensing application function network element. The first sensing request is configured to indicate the first sensing entity to start to transmit data, that is, the first sensing request notifies the wireless access point that data may start to be transmitted.

In S560, a first response message is transmitted to the sensing application function network element via the first sensing entity by the wireless access point.

In some examples, after receiving the first sensing request, the wireless access point may transmit the first response message to the sensing application function network element via the first sensing entity. The first response message includes confirmation for data transmission, such that the sensing application function network element is notified through the first response message that the wireless access point is ready to start to transmit the data.

In S570, a second sensing request is received from the sensing application function network element by the wireless access point.

In some implementations, after the second sensing registration accept message is received from the sensing application function network element by the wireless access point, the wireless access point may receive the second sensing request from the sensing application function network element. The second sensing request is configured to indicate the second sensing entity to start to receive data, that is, the second sensing request notifies the wireless access point that data may start to be received.

In S580, a second response message is transmitted to the sensing application function network element via the second sensing entity by the wireless access point.

In some examples, after receiving the second sensing request, the wireless access point may transmit the second response message to the sensing application function network element through the second sensing entity. The second response message includes at least one of sensing measurement data or a sensing measurement result.

In conclusion, in the embodiment of the present disclosure, the wireless access point may be used as a transmitter or a receiver.

The implementation solution, identical to the embodiment, of the embodiment of the present disclosure will not be repeated. Reference may be made to introduction of the embodiment for details.

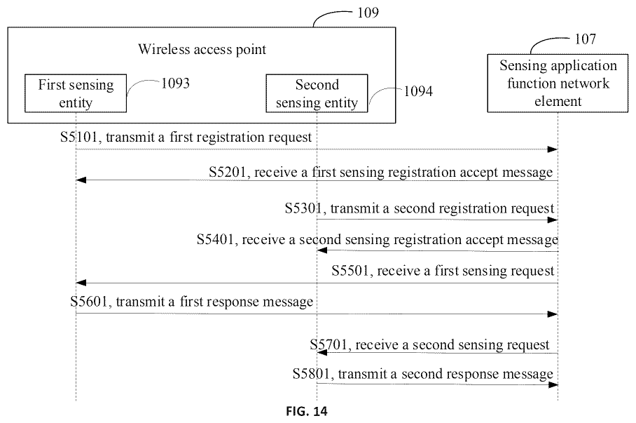

FIG. 14 is a communication sequence chart of a sensing method for a mobile network according to some another embodiments. As shown in FIG. 14, a first registration request may be transmitted (S5101) to a sensing application function network element 107 by a first sensing entity 1093 of a wireless access point 109. Further, a first sensing registration accept message may be transmitted (S5201) to the wireless access point 109 including the first sensing entity 1093 by the sensing application function network element 107. Meanwhile, a second registration request may be transmitted (S5301) to the sensing application function network element 107 by a second sensing entity 1094 of a wireless access point 109. A second sensing registration accept message may be transmitted (S5401) to the wireless access point 109 including the second sensing entity 1094 by the sensing application function network element 107. Based on this, in response to a first sensing request transmitted (S5501) by the sensing application function network element 107, the first sensing entity 1093 of the wireless access point 109 may transmit (S5601) a first response message to the sensing application function network element 107. Meanwhile, in response to a second sensing request transmitted (S5701) by the sensing application function network element 107, the second sensing entity 1094 of the wireless access point 109 may transmit (S5801) a second response message to the sensing application function network element 107.

In the embodiments of the present disclosure, in response to the trigger-sensing request, the registration request may be transmitted to the sensing application function network element by the wireless access point, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element. In addition, the embodiment of the present disclosure may combine a 3GPP network with a Wi-Fi network, and further provide a sensing-based service. Through the mobile network and radio interface Wi-Fi, an operator may provide a responsive sensing service, and further network sensing may be conducted more conveniently.

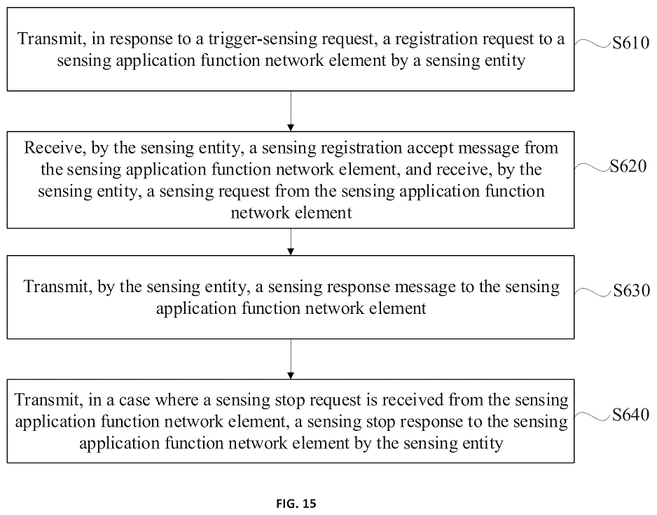

FIG. 15 is a flowchart of a sensing method for a mobile network according to some another embodiments. As shown in FIG. 15, the sensing method for a mobile network may be performed by the sensing entity in FIG. 1. The method may include the following steps S610 to S640.

In S610, in response to a trigger-sensing request, a registration request is transmitted to a sensing application function network element by the sensing entity.

In S620, a sensing registration accept message is received from the sensing application function network element by the sensing entity, and a sensing request is received from the sensing application function network element.

In S630, a sensing response message is transmitted to the sensing application function network element by the sensing entity.

Implementations of S610 to S630 are described in the embodiment, and will not be repeated.

In S640, in a case where a sensing stop request is received from the sensing application function network element, a sensing stop response is transmitted to the sensing application function network element by the sensing entity.

In some examples, after transmitting the sensing response message to the sensing application function network element, the sensing entity may receive the sensing stop request received from the sensing application function network element, and transmit the sensing stop response to the sensing application function network element.

In the embodiment of the present disclosure, after completing a sensing service, the sensing application function network element may transmit a sensing stop request to the sensing entity. In a case where the sensing stop request is received from the sensing application function network element, the sensing entity transmits the sensing stop response to the sensing application function network element, that is, stops transmission of a sensing signal.

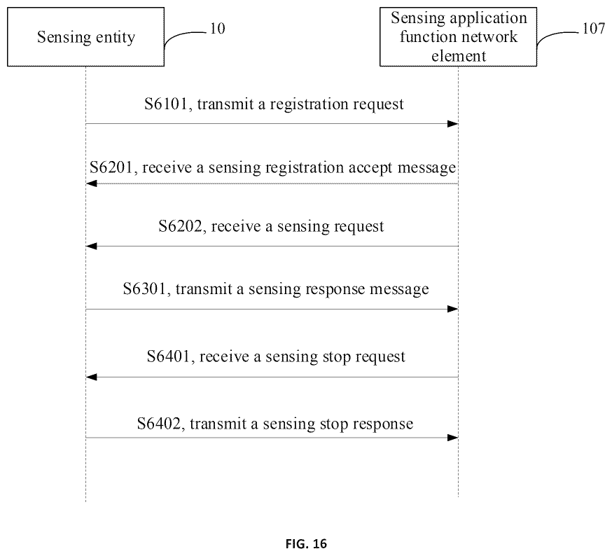

FIG. 16 is a communication sequence chart of a sensing method for a mobile network according to some another embodiments. As shown in FIG. 16, the sensing entity 10 may transmit (S6101) the registration request to the sensing application function network element 107. The sensing application function network element 107 may transmit (S6201) the sensing registration accept message to the sensing entity 10 after receiving the registration request. The sensing entity 10 may receive (S6202) the sensing request transmitted by the sensing application function network element 107 and transmit (S6301) the sensing response message to the sensing application function network element 107. Based on this, the sensing entity 10 may receive the sensing stop request transmitted (S6401) by the sensing application function network element 107, and transmit (S6402) the sensing stop response to the sensing application function network element 107.

In the embodiments of the present disclosure, in response to the trigger-sensing request, the registration request may be transmitted to the sensing application function network element by the sensing entity, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element. In addition, the present disclosure can reduce unnecessary power consumption caused by mobile network sensing by receiving the sensing stop request from the sensing application function network element.

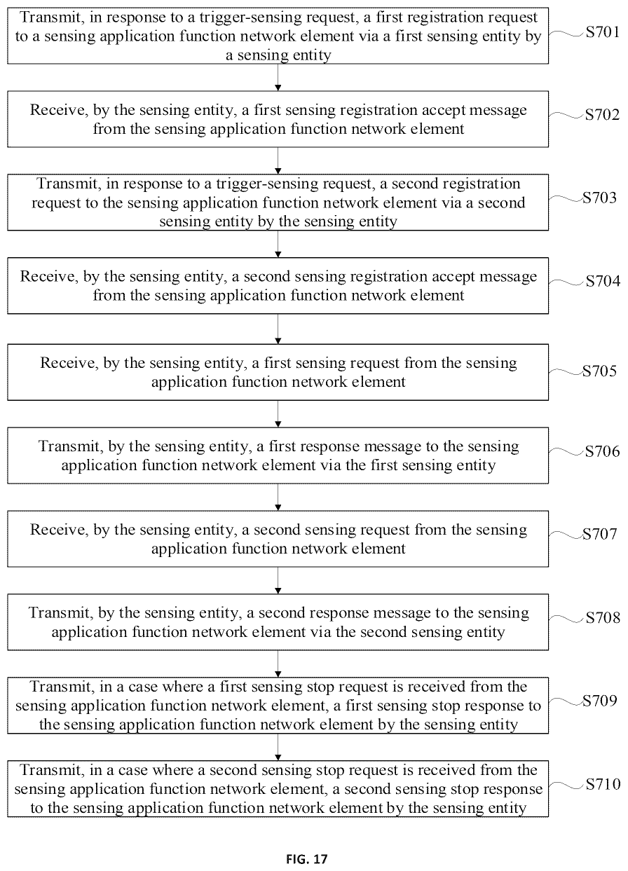

FIG. 17 is a flowchart of a sensing method for a mobile network according to some other embodiments. As shown in FIG. 17, the sensing method for a mobile network may be performed by the sensing entity in FIG. 1. The method may include the following steps S701 to S710.

In S701, in response to a trigger-sensing request, a first registration request is transmitted to a sensing application function network element via a first sensing entity by the sensing entity.

In S702, a first sensing registration accept message is received from the sensing application function network element by the sensing entity.

In S703, in response to the trigger-sensing request, a second registration request is transmitted to the sensing application function network element via a second sensing entity by the sensing entity.

In S704, a second sensing registration accept message is received from the sensing application function network element by the sensing entity.

In S705, a first sensing request is received from the sensing application function network element by the sensing entity.

In S706, a first response message is transmitted to the sensing application function network element via the first sensing entity by the sensing entity.

In S707, a second sensing request is received from the sensing application function network element by the sensing entity.

In S708, a second response message is transmitted to the sensing application function network element via the second sensing entity by the sensing entity.

Reference may be made to introduction of the embodiment for implementations of S701 to S707, which will not be repeated.

In S709, in a case where a first sensing stop request is received from the sensing application function network element, a first sensing stop response is transmitted to the sensing application function network element by the sensing entity.

In the embodiment of the present disclosure, after receiving the first sensing stop request transmitted by the sensing application function network element, the sensing entity may transmit the first sensing stop response to the sensing application function network element. The first sensing stop response is configured to indicate that the sensing application function network element stops transmission of sensed data.

S710, in a case where a second sensing stop request is received from the sensing application function network element, a second sensing stop response is transmitted to the sensing application function network element by the sensing entity.

In the embodiment of the present disclosure, after receiving the second sensing stop request transmitted by the sensing application function network element, the sensing entity transmits the second sensing stop response to the sensing application function network element. The second sensing stop response is configured to indicate that the sensing application function network element stops reception of sensed data.

In the embodiment of the present disclosure, the sensing entity may include at least one of the user equipment or the wireless access point. The user equipment may include the first sensing entity, and the wireless access point may include the second sensing entity. Alternatively, the user equipment may include the second sensing entity, and the wireless access point may include the first sensing entity. Alternatively, the user equipment may include the first sensing entity and the second sensing entity. Alternatively, the wireless access point may include the first sensing entity and the second sensing entity. How the user equipment and the wireless access point use the first sensing entity and the second sensing entity for mobile network sensing is described in detail in the embodiment, and will not be repeated.

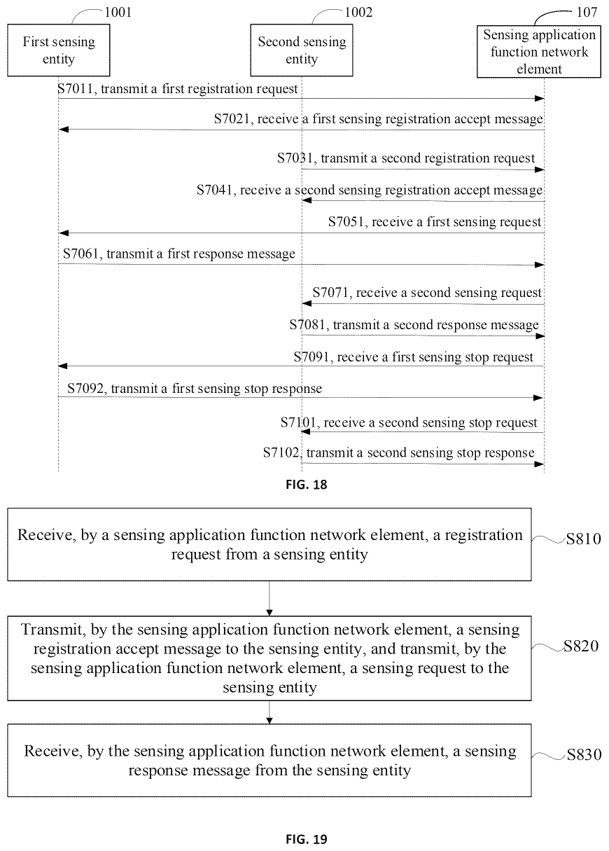

FIG. 18 is a communication sequence chart of a sensing method for a mobile network according to some other embodiments. As shown in FIG. 18, a first registration request may be transmitted (S7011) to a sensing application function network element 107 by a first sensing entity 1001 of a sensing entity, and a first sensing registration accept message may be transmitted (S7021) to the sensing entity including the first sensing entity 1001 by the sensing application function network element 107. Meanwhile, a second registration request may be transmitted (S7031) to the sensing application function network element 107 by a second sensing entity 1002 of the sensing entity, and a second sensing registration accept message may be transmitted (S7041) to the sensing entity including the second sensing entity 1002 by the sensing application function network element 107. Based on this, in response to a first sensing request transmitted (S7051) by the sensing application function network element 107, the first sensing entity 1001 of the sensing entity may transmit (S7061) a first response message to the sensing application function network element 107. Meanwhile, in response to a second sensing request transmitted (S7071) by the sensing application function network element 107, the second sensing entity 1002 of the sensing entity may transmit (S7081) a second response message to the sensing application function network element 107. In addition, the first sensing entity 1001 of the sensing entity may receive (S7091) a first sensing stop request transmitted by the sensing application function network element 107, and then transmit (S7092) a first sensing stop response to the sensing application function network element 107. Meanwhile, the second sensing entity 1002 of the sensing entity may receive (S7101) a second sensing stop request transmitted by the sensing application function network element 107, and then transmit (S7102) a second sensing stop response to the sensing application function network element 107.

In the embodiments of the present disclosure, in response to the trigger-sensing request, the registration request may be transmitted to the sensing application function network element by the sensing entity, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element. In addition, the present disclosure can reduce unnecessary power consumption caused by mobile network sensing by receiving the first sensing stop request and the second sensing stop request from the sensing application function network element.

FIG. 19 is a flowchart of a sensing method for a mobile network according to some embodiments. As shown in FIG. 19, the sensing method for a mobile network may be performed by the sensing application function network element in FIG. 3. The method may include the following steps S810 to S830.

In S810, a registration request is received from a sensing entity by the sensing application function network element.

In some implementations, the sensing entity may include at least one of user equipment or a wireless access point. The user equipment includes a first sensing entity, and the wireless access point includes a second sensing entity. Alternatively, the user equipment includes a second sensing entity, and the wireless access point includes a first sensing entity. Alternatively, the user equipment includes a first sensing entity and a second sensing entity. Alternatively, the wireless access point includes a first sensing entity and a second sensing entity.

In some other implementations, the step that the registration request is received from the sensing entity may include the following step: a first registration request is received from the sensing entity. The first registration request may be configured to indicate that a type of the sensing entity is at least one of the user equipment or the wireless access point, and the first registration request is configured to indicate that the first sensing entity has a capability of a transmitter. In addition, the present disclosure may receive a second registration request from the sensing entity. The second registration request is configured to indicate that the type of the sensing entity is at least one of the user equipment or the wireless access point, and the second registration request is configured to indicate that the second sensing entity has a capability of a receiver.

In S820, a sensing registration accept message is transmitted to the sensing entity by the sensing application function network element, and a sensing request is transmitted to the sensing entity.

In some implementations, the step that the sensing registration accept message is transmitted to the sensing entity may include the following step: a first sensing registration accept message is transmitted to the sensing entity. The first sensing registration accept message may be configured to indicate the first sensing entity as a transmitter. In addition, the present disclosure may transmit a second sensing registration accept message to the sensing entity. The second sensing registration accept message is configured to indicate the second sensing entity as a receiver.

In some other implementations, the step that the trigger-sensing request is transmitted to the sensing entity may include the following step: a first sensing request is transmitted to the sensing entity. The first sensing request is configured to indicate that the first sensing entity to start transmitting data. In addition, the present disclosure may transmit a second sensing request to the sensing entity. The second sensing request is configured to indicate that the second sensing entity to start receiving data.

In S830, a sensing response message is received from the sensing entity by the sensing application function network element.

In some implementations, the step that the sensing response message is received from the sensing entity may include the following step: a first response message is received from the first sensing entity of the sensing entity. The first response message includes confirmation for data transmission. In addition, the present disclosure may receive a second response message from the second sensing entity of the sensing entity. The second response message may include at least one of sensing measurement data or a sensing measurement result.

In some implementations, after the sensing response message is received from the sensing entity, the embodiment of the present disclosure may indicate the sensing entity to stop performing a sensing operation by transmitting a sensing stop request to the sensing entity.

In the embodiments of the present disclosure, the sensing application function network element may receive the registration request from the sensing entity. The registration request may include the type of the sensing entity and the capability of the sensing entity. Further, the sensing application function network element is configured to provide the sensing service for the sensing entity. Based on this, the sensing application function network element may transmit the sensing registration accept message and the sensing request to the sensing entity, and then may receive the sensing response message from the sensing entity. Since the sensing application function network element belongs to the mobile network, the present disclosure may achieve sensing of the mobile network by combining the sensing entity and the sensing application function network element.

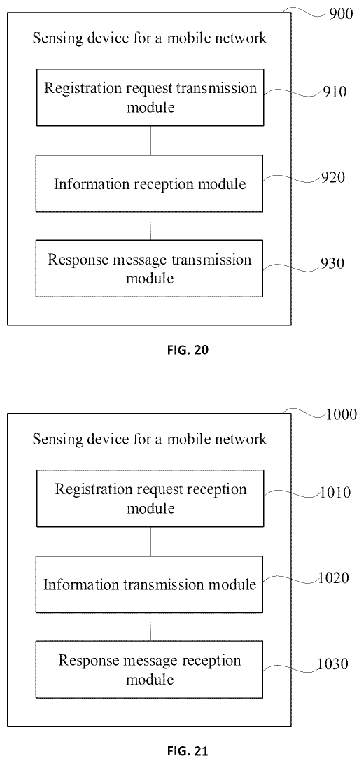

FIG. 20 is a block diagram of a sensing device 900 for a mobile network according to some embodiments. With reference to FIG. 20, the sensing device 900 for a mobile network is applied to a sensing entity. The sensing device 900 for a mobile network may include a registration request transmission module 910, an information reception module 920, and a response message transmission module 930.

The registration request transmission module 910 is configured to transmit, in response to a trigger-sensing request, a registration request to a sensing application function network element. The registration request includes a type of the sensing entity and a capability of the sensing entity. The sensing application function network element is configured to provide a sensing service for the sensing entity.

The information reception module 920 is configured to receive a sensing registration accept message from the sensing application function network element, and receive a sensing request from the sensing application function network element.

The response message transmission module 930 is configured to transmit a sensing response message to the sensing application function network element.

In some implementations, the sensing entity includes at least one of user equipment or a wireless access point. The user equipment includes a first sensing entity, and the wireless access point includes a second sensing entity. Alternatively, the user equipment includes a second sensing entity, and the wireless access point includes a first sensing entity. Alternatively, the user equipment includes a first sensing entity and a second sensing entity. Alternatively, the wireless access point includes a first sensing entity and a second sensing entity.

In some implementations, the registration request transmission module 910 may include:
a first registration request transmission sub-module (not shown) configured to transmit, in response to the trigger-sensing request, a first registration request to the sensing application function network element by the first sensing entity, where the first registration request is configured to indicate that the type of the sensing entity is at least one of the user equipment or the wireless access point, and the first registration request is configured to indicate that the first sensing entity has a capability of a transmitter; and
a second registration request transmission sub-module (not shown) configured to transmit, in response to the trigger-sensing request, a second registration request to the sensing application function network element by the second sensing entity, where the second registration request is configured to indicate that the type of the sensing entity is at least one of the user equipment or the wireless access point, and the second registration request is configured to indicate that the second sensing entity has a capability of a receiver.

In some implementations, the information reception module 920 may include:
a first sensing registration accept message reception sub-module (not shown) configured to receive a first sensing registration accept message from the sensing application function network element, where the first sensing registration accept message is configured to indicate the first sensing entity as a transmitter; and
a second sensing registration accept message reception sub-module (not shown) configured to receive a second sensing registration accept message from the sensing application function network element, where the second sensing registration accept message is configured to indicate the second sensing entity as a receiver.

In some implementations, the information reception module 920 may further include:
a first sensing request reception sub-module (not shown) configured to receive a first sensing request from the sensing application function network element, where the first sensing request is configured to indicate the first sensing entity to start transmitting data; and
a second sensing request reception sub-module (not shown) configured to receive a second sensing request from the sensing application function network element, where the second sensing request is configured to indicate the second sensing entity to start receiving data.

In some implementations, the response message transmission module 930 may include:
a first response message transmission sub-module (not shown) configured to transmit a first response message to the sensing application function network element by the first sensing entity, where the first response message includes confirmation for data transmission; and
a second response message transmission sub-module (not shown) configured to transmit a second response message to the sensing application function network element by the second sensing entity, where the second response message includes at least one of sensing measurement data or a sensing measurement result.

In some implementations, the wireless access point is provided by a trusted non-3GPP or the wireless access point is provided by an untrusted non-3GPP.

In some implementations, the non-3GPP includes Wi-Fi.

In some implementations, the sensing device 900 for a mobile network may further include:
a sensing stop response transmission module (not shown) configured to transmit, in a case where a sensing stop request is received from the sensing application function network element, a sensing stop response to the sensing application function network element.

In some implementations, the registration request further includes at least one of an identifier of the sensing entity or a location of the sensing entity.

The identifier of the sensing entity includes at least one of:
a generic public subscription identifier of user equipment;
a basic service set identifier of Wi-Fi; or
an MAC address.

In some implementations, the capability of the sensing entity includes at least one of:
a Wi-Fi capable sensing;
supporting at least one of transmitter or receiver;
a sensing range of at least one of the transmitter or the receiver;
a supported radio frequency; or
sensing accuracy.

In the embodiments of the present disclosure, in response to the trigger-sensing request, the registration request may be transmitted to the sensing application function network element by the sensing entity, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element.

FIG. 21 is a block diagram of a sensing device 1000 for a mobile network according to some embodiments. With reference to FIG. 21, the sensing device 1000 for a mobile network is applied to a sensing application function network element. The sensing device 1000 for a mobile network may include a registration request reception module 1010, an information transmission module 1020, and a response message reception module 1030.

The registration request reception module 1010 is configured to receive a registration request from a sensing entity. The registration request includes a type of the sensing entity and a capability of the sensing entity. The sensing application function network element is configured to provide a sensing service for the sensing entity.

The information transmission module 1020 is configured to transmit a sensing registration accept message to the sensing entity, and transmit a sensing request to the sensing entity.

The response message reception module 1030 is configured to receive a sensing response message from the sensing entity.

In some implementations, the sensing entity includes at least one of user equipment or a wireless access point. The user equipment includes a first sensing entity, and the wireless access point includes a second sensing entity. Alternatively, the user equipment includes a second sensing entity, and the wireless access point includes a first sensing entity. Alternatively, the user equipment includes a first sensing entity and a second sensing entity. Alternatively, the wireless access point includes a first sensing entity and a second sensing entity.

In some implementations, the registration request reception module 1010 may include:
a first registration request reception sub-module (not shown) configured to receive a first registration request from the sensing entity, where the first registration request is configured to indicate that the type of the sensing entity is at least one of the user equipment or the wireless access point, and the first registration request is configured to indicate that the first sensing entity has a capability of a transmitter; and
a second registration request reception sub-module (not shown) configured to receive a second registration request from the sensing entity, where the second registration request is configured to indicate that the type of the sensing entity is at least one of the user equipment or the wireless access point, and the second registration request is configured to indicate that the second sensing entity has a capability of a receiver.

In some implementations, the information transmission module 1020 may include:
a first sensing registration accept message transmission sub-module (not shown) configured to transmit a first sensing registration accept message to the sensing entity, where the first sensing registration accept message is configured to indicate the first sensing entity as a transmitter; and
a second sensing registration accept message transmission sub-module (not shown) configured to transmit a second sensing registration accept message to the sensing entity, where the second sensing registration accept message is configured to indicate the second sensing entity as a receiver.

In some implementations, the information transmission module 1020 may further include:
a first sensing request transmission sub-module (not shown) configured to transmit a first sensing request to the sensing entity, where the first sensing request is configured to indicate the first sensing entity to start transmitting data; and
a second sensing request reception sub-module (not shown) configured to transmit a second sensing request to the sensing entity, where the second sensing request is configured to indicate the second sensing entity to start receiving data.

In some implementations, the response message reception module 1030 may include:
a first response message reception sub-module (not shown) configured to receive a first response message from the first sensing entity of the sensing entity, where the first response message includes confirmation for data transmission; and
a second response message reception sub-module (not shown) configured to receive a second response message from the second sensing entity of the sensing entity, where the second response message includes at least one of sensing measurement data or a sensing measurement result.

In some implementations, the sensing device 900 for a mobile network may further include:
a sensing stop request transmission module (not shown) configured to indicate the sensing entity to stop performing a sensing operation by transmitting a sensing stop request to the sensing entity.

In the embodiments of the present disclosure, the sensing application function network element may receive the registration request from the sensing entity. The registration request may include the type of the sensing entity and the capability of the sensing entity. Further, the sensing application function network element is configured to provide the sensing service for the sensing entity. Based on this, the sensing application function network element may transmit the sensing registration accept message and the sensing request to the sensing entity, and then may receive the sensing response message from the sensing entity. Since the sensing application function network element belongs to the mobile network, the present disclosure may achieve sensing of the mobile network by combining the sensing entity and the sensing application function network element.

For the device in the embodiments, a method for each module to execute an operation is described in detail in the embodiments relating to the method, and will not be described in detail.

The present disclosure further provides a non-transitory computer-readable storage medium, which stores a computer program instruction. The computer program instruction, when executed by a processor, implements the steps of the sensing method for a mobile network according to the present disclosure.

As used herein, the term “processor” may refer to one processor that performs the defined functions or a plurality of processors that collectively perform defined functions, such that the execution of the individual defined functions may be divided amongst such processors.

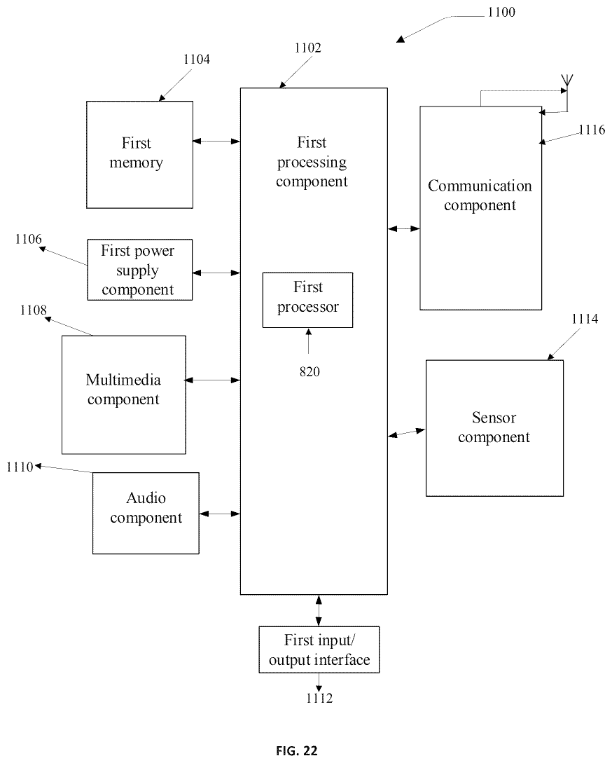

FIG. 22 is a block diagram of a sensing entity according to some embodiments. In the embodiment of the present disclosure, the sensing entity may be user equipment, a wireless access point, or a gateway. For instance, the sensing entity 1100 may be a mobile phone, a computer, a digital broadcast terminal, a messaging device, a game console, a tablet device, a medical device, a fitness device, a personal digital assistant, an intelligent vehicle, etc.

With reference to FIG. 22, the sensing entity 1100 may include one or more of the following components: a first processing component 1102, a first memory 1104, a first power supply component 1106, a multimedia component 1108, an audio component 1110, a first input/output interface 1112, a sensor component 1114, and a communication component 1116.

The first processing component 1102 generally controls all operation of the sensing entity 1100, such as operations associated with display, telephone call, data communication, camera operation and recording operation. The first processing component 1102 may include one or more first processors 1120 configured to execute an instruction, so as to complete all or some steps of the sensing method for a mobile network. In addition, the first processing component 1102 may include one or more modules to facilitate interaction between the first processing component 1102 and other components. For instance, the first processing component 1102 may include a multimedia module to facilitate interaction between the multimedia component 1108 and the first processing component 1102.

The first memory 1104 is configured to store various types of data, so as to support the operation on the sensing entity 1100. Instances of the data include an instruction for any application or method operating on the sensing entity 1100, contact data, phone book data, a message, a picture, a video, etc. The first memory 1104 may be implemented by any type of volatile or nonvolatile memory device or their combinations, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk, or an optical disk.

The first power supply component 1106 supplies power to various components of the sensing entity 1100. The first power supply component 1106 may include a power management system, one or more power supplies, and other components associated with generating, managing and distributing power for the sensing entity 1100.

The multimedia component 1108 includes a screen that provides an output interface between the sensing entity 1100 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense touch, slide and gestures on the touch panel. The touch sensor may sense a boundary of touch or slide operation, and detect duration and pressure related to the touch or slide operation. In some embodiments, the multimedia component 1108 includes a front-facing camera and/or a rear-facing camera. When the sensing entity 1100 is in an operation mode, such as a photographing mode or a video mode, the front-facing camera and/or the rear-facing camera are/is capable of receiving external multimedia data. Each of the front-facing camera and the rear-facing camera may be a fixed optical lens system or have a focal length and an optical zoom capability.

The audio component 1110 is configured to output and/or input an audio signal. For instance, the audio component 1110 includes a microphone (MIC). The microphone is configured to receive an external audio signal when the sensing entity 1100 is in operation modes such as a call mode, a recording mode and a voice identification mode. The received audio signal may be further stored in the first memory 1104 or transmitted via the communication component 1116. In some embodiments, the audio component 1110 further includes a speaker configured to output an audio signal.

The first input/output interface 1112 provides an interface between the first processing component 1102 and a peripheral interface module. The peripheral interface module may be a keyboard, a click wheel, a button, etc. The buttons may include, but are not limited to, a home button, a volume button, a start button, and a lock button.

The sensor component 1114 includes one or more sensors for providing various aspects of state assessment for the sensing entity 1100. For instance, the sensor component 1114 is capable of detecting an on/off state of the sensing entity 1100 and relative positioning of the components, such as a display and a keypad of the sensing entity 1100, and the sensor component 1114 is further capable of detecting position change of the sensing entity 1100 or a component of the sensing entity 1100, presence or absence of contact between the user and the sensing entity 1100, an orientation or acceleration/deceleration of the sensing entity 1100, and temperature change of the sensing entity 1100. The sensor component 1114 may include a proximity sensor configured to detect presence of a nearby object without any physical contact. The sensor component 1114 may further include an optical sensor, such as a complementary metal-oxide-semiconductor (CMOS) or charge-coupled device (CCD) image sensor, which is used in an imaging application. In some embodiments, the sensor component 1114 may further include an acceleration sensor, a gyroscope sensor, a magnetic sensor, a pressure sensor, or a temperature sensor.

The communication component 1116 is configured to facilitate wired or radio communication between the sensing entity 1100 and other devices. The sensing entity 1100 may access a radio network based on a communication standard, such as Wi-Fi, the 2nd generation mobile communication technology (2G) or 3G, or their combination. In one example, the communication component 1116 receives a broadcast signal or broadcast related information from an external broadcast management system via a broadcast channel. In one example, the communication component 1116 further includes a near field communication (NFC) module to facilitate short-range communication. For instance, the NFC module may be implemented on the basis of a radio frequency identification (RFID) technology, an infrared data association (IrDA) technology, an ultra-wideband (UWB) technology, a Bluetooth (BT) technology or other technologies.

In an example, the sensing entity 1100 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic components, thus performing the sensing method for a mobile network.

In an example, a non-transitory computer-readable storage medium including an instruction is further provided, such as the first memory 1104 including an instruction. The instruction may be executed by the first processor 1120 of the sensing entity 1100 so as to complete the sensing method for a mobile network. For instance, the non-transitory computer-readable storage medium may be an ROM, a random access memory (RAM), a compact disc-read only memory (CD-ROM), a magnetic tape, a floppy disk, an optical data storage device, etc.

The device may be an independent electronic device or part of an independent electronic device. For instance, in an embodiment, the apparatus may be an integrated circuit (IC) or a chip, where the integrated circuit may be an IC or a collection of a plurality of ICs. The chip may include, but is not limited to, the following types: a graphics processing unit (GPU), a central processing unit (CPU), an FPGA, a DSP, an ASIC, a system on chip (SoC), etc. The integrated circuit or chip may be used for executing an executable instruction (or a code), so as to implement the sensing method for a mobile network. The executable instruction may be stored in the integrated circuit or chip, or may be obtained from other apparatuses or devices. For instance, the integrated circuit or chip includes a processor, a memory, and an interface for communication with other apparatuses. The executable instruction may be stored in the memory. The executable instruction, when executed by the processor, implements the sensing method for a mobile network. Alternatively, the integrated circuit or chip may receive the executable instruction through the interface and transmit the instruction to the processor for execution, so as to implement the sensing method for a mobile network.

In another example, a computer program product is further provided and includes a computer program executable by a programmable apparatus. The computer program has a code part for performing, when executed by the programmable apparatus, the sensing method for a mobile network.

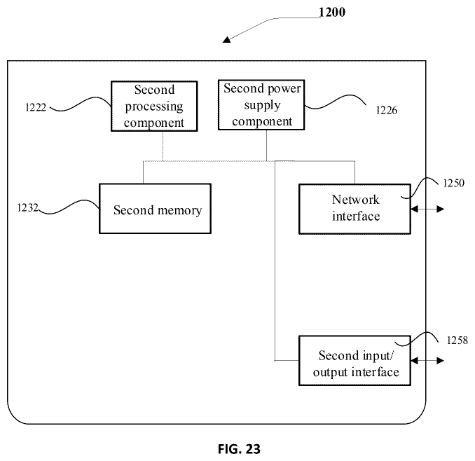

FIG. 23 is a block diagram of a sensing application function network element according to one example. For instance, the sensing application function network element 1200 may be provided as a server. With reference to FIG. 23, the sensing application function network element 1200 includes a second processing component 1222, which further includes one or more processors, and a memory resource represented by a second memory 1232. The memory resource is used for storing an instruction executable by the second processing component 1222, such as an application. The application stored in the second memory 1232 may include one or more modules that each correspond to a group of instructions. In addition, the second processing component 1222 is configured to execute the instruction, so as to perform the sensing method for a mobile network.

The sensing application function network element 1200 may further include a second power supply component 1226 configured to perform power management of the sensing application function network element 1200, a wired or radio network interface 1250 configured to connect the sensing application function network element 1200 to a network, and a second input/output interface 1258. The sensing application function network element 1200 may operate an operating system stored in the memory 1232, such as Windows Server™, Mac OS X™, Unix™, Linux™, and FreeBSD™.

The technical solution provided by the embodiments of the present disclosure may have the following beneficial effects: in response to the trigger-sensing request, the registration request is transmitted to the sensing application function network element, the registration request may include the type of the sensing entity and the capability of the sensing entity. Further, the sensing application function network element is configured to provide the sensing service for the sensing entity. Based on this, the sensing registration accept message and the sensing request are received from the sensing application function network element, and then the sensing response message is transmitted to the sensing application function network element. Since the sensing application function network element belongs to the mobile network, the present disclosure may achieve sensing of the mobile network by combining the sensing entity and the sensing application function network element.

Those skilled in the art could easily conceive of other implementation solutions of the present disclosure upon consideration of the description and practice of the present disclosure. The present disclosure is intended to cover any variations, uses or adaptive changes of the present disclosure, which follow the general principles of the present disclosure and include common general knowledge or conventional technical means in the art not disclosed in the present disclosure. The description and the embodiments are regarded as merely illustrative, and the true scope and spirit of the present disclosure are indicated by the following claims.

It is to be understood that the present disclosure is not limited to a precise structure described and illustrated in the accompanying drawings, and can be subjected to various modifications and changes without departing from the scope. The scope of the present disclosure is limited merely by the appended claims.

1. A sensing method for mobile network, performed by a sensing entity, the sensing method comprising:
transmitting, in response to a trigger-sensing request, a registration request to a sensing application function network element, wherein the registration request comprises a type of the sensing entity and a capability of the sensing entity, and the sensing application function network element is configured to provide a sensing service for the sensing entity;
receiving a sensing registration accept message from the sensing application function network element, and receiving a sensing request from the sensing application function network element; and
transmitting a sensing response message to the sensing application function network element.

2. The sensing method according to claim 1, wherein the sensing entity comprises at least one of user equipment or a wireless access point, wherein the user equipment comprises a first sensing entity, and the wireless access point comprises a second sensing entity; or
the user equipment comprises the second sensing entity, and the wireless access point comprises the first sensing entity; or
the user equipment comprises the first sensing entity and the second sensing entity; or
the wireless access point comprises the first sensing entity and the second sensing entity.

3. The sensing method according to claim 2, wherein transmitting, in response to the trigger sensing request, the registration request to the sensing application function network element comprises:
transmitting, in response to the trigger sensing request, a first registration request to the sensing application function network element by the first sensing entity, wherein the first registration request is configured to indicate that the type of the sensing entity is at least one of the user equipment or the wireless access point, and the first registration request is configured to indicate that the first sensing entity has a capability of a transmitter; and
transmitting, in response to the trigger sensing request, a second registration request to the sensing application function network element by the second sensing entity, wherein the second registration request is configured to indicate that the type of the sensing entity is at least one of the user equipment or the wireless access point, and the second registration request is configured to indicate that the second sensing entity has a capability of a receiver.

4. The sensing method according to claim 2, wherein receiving the sensing registration accept message from the sensing application function network element comprises:
receiving a first sensing registration accept message from the sensing application function network element, wherein the first sensing registration accept message is configured to indicate the first sensing entity as a transmitter; and
receiving a second sensing registration accept message from the sensing application function network element, wherein the second sensing registration accept message is configured to indicate the second sensing entity as a receiver.

5. The sensing method according to claim 2, wherein receiving the sensing request from the sensing application function network element comprises:
receiving a first sensing request from the sensing application function network element, wherein the first sensing request is configured to indicate the first sensing entity to start transmitting data; and
receiving a second sensing request from the sensing application function network element, wherein the second sensing request is configured to indicate the second sensing entity to start receiving data.

6. The sensing method according to claim 2, wherein transmitting the sensing response message to the sensing application function network element comprises:
transmitting a first response message to the sensing application function network element by the first sensing entity, wherein the first response message comprises confirmation for data transmission; and
transmitting a second response message to the sensing application function network element by the second sensing entity, wherein the second response message comprises at least one of sensing measurement data or a sensing measurement result.

7. The sensing method according to claim 2, wherein the wireless access point is provided by a trusted non-3rd generation partnership project (3GPP) or the wireless access point is provided by an untrusted non-3GPP, and the trusted or untrusted non-3GPP comprises wireless fidelity (Wi-Fi).

8. (canceled)

9. The sensing method according to claim 1, wherein after transmitting the sensing response message to the sensing application function network element, the sensing method further comprises:
transmitting, in a case where a sensing stop request is received from the sensing application function network element, a sensing stop response to the sensing application function network element.

10. The sensing method according to claim 1, wherein the registration request further comprises at least one of an identifier of the sensing entity or a location of the sensing entity; and
the identifier of the sensing entity comprises at least one of the following:
a generic public subscription identifier of user equipment;
a basic service set identifier of wireless fidelity (Wi-Fi); or
a media access control (MAC) address.

11. The sensing method according to claim 1, wherein the capability of the sensing entity comprises at least one of the following:
a wireless fidelity (Wi-Fi) capable sensing;
supporting at least one of a transmitter or a receiver;
a sensing range of at least one of the transmitter or the receiver;
a supported radio frequency; or
sensing accuracy.

12. A sensing method for mobile network, performed by a sensing application function network element, the sensing method comprising:
receiving a registration request from a sensing entity, wherein the registration request comprises a type of the sensing entity and a capability of the sensing entity, and the sensing application function network element is configured to provide a sensing service for the sensing entity;
transmitting a sensing registration accept message to the sensing entity, and transmitting a sensing request to the sensing entity; and
receiving a sensing response message from the sensing entity.

13. The sensing method according to claim 12, wherein the sensing entity comprises at least one of user equipment or a wireless access point, wherein the user equipment comprises a first sensing entity, and the wireless access point comprises a second sensing entity; or
the user equipment comprises the second sensing entity, and the wireless access point comprises the first sensing entity; or
the user equipment comprises the first sensing entity and the second sensing entity; or
the wireless access point comprises the first sensing entity and the second sensing entity.

14. The sensing method according to claim 13, wherein receiving the registration request from the sensing entity comprises:
receiving a first registration request from the sensing entity, wherein the first registration request is configured to indicate that the type of the sensing entity is at least one of the user equipment or the wireless access point, and the first registration request is configured to indicate that the first sensing entity has a capability of a transmitter; and
receiving a second registration request from the sensing entity, wherein the second registration request is configured to indicate that the type of the sensing entity is at least one of the user equipment or the wireless access point, and the second registration request is configured to indicate that the second sensing entity has a capability of a receiver.

15. The sensing method according to claim 13, wherein transmitting the sensing registration accept message to the sensing entity comprises:
transmitting a first sensing registration accept message to the sensing entity, wherein the first sensing registration accept message is configured to indicate the first sensing entity as a transmitter; and
transmitting a second sensing registration accept message to the sensing entity, wherein the second sensing registration accept message is configured to indicate the second sensing entity as a receiver.

16. The sensing method according to claim 13, wherein transmitting the sensing request to the sensing entity comprises:
transmitting a first sensing request to the sensing entity, wherein the first sensing request is configured to indicate the first sensing entity to start transmitting data; and
transmitting a second sensing request to the sensing entity, wherein the second sensing request is configured to indicate the second sensing entity to start receiving data.

17. The sensing method according to claim 13, wherein receiving the sensing response message from the sensing entity comprises:
receiving a first response message from the first sensing entity of the sensing entity, wherein the first response message comprises confirmation for data transmission; and
receiving a second response message from the second sensing entity of the sensing entity, wherein the second response message comprises at least one of sensing measurement data or a sensing measurement result.

18. The sensing method according to claim 12, wherein after receiving the sensing response message from the sensing entity, the sensing method further comprises:
transmitting a sensing stop request to the sensing entity, to indicate the sensing entity to stop performing a sensing operation.

19-20. (canceled)

21. A sensing entity, comprising:
one or more processors; and
a memory configured to store processor-executable instructions,
wherein the one or more processors are collectively configured to execute the processor-executable instructions to cause the sensing entity to
transmit, in response to a trigger-sensing request, a registration request to a sensing application function network element, wherein the registration request comprises a type of the sensing entity and a capability of the sensing entity, and the sensing application function network element is configured to provide a sensing service for the sensing entity;
receive a sensing registration accept message from the sensing application function network element, and receive a sensing request from the sensing application function network element; and
transmit a sensing response message to the sensing application function network element.

22. A sensing application function network element, comprising:
one or more processors; and
a memory configured to store processor-executable instructions, wherein the one or more processors are collectively configured to perform the sensing method according to any one of claim 12 by executing the processor-executable instructions.

23. A non-transitory computer-readable storage medium, storing computer program instructions, wherein the computer program instructions, when executed by a processor, cause the sensing entity to perform the sensing method according to claim 1.
